(19) United States
(12) Patent Application Publication
(10) Pub. No.: US 2026/0163085 A1
(43) Pub. Date: Jun. 11, 2026

(54) ELECTRONIC DEVICE AND BATTERY MANAGEMENT METHOD THEREOF

(71) Applicant: ASUSTeK COMPUTER INC., Taipei City (TW)

(72) Inventors: Ying-Yui Wu, Taipei City (TW); Chia-Sen Chang, Taipei City (TW); Chunyen Lai, Taipei City (TW); Yu-Hsiu Su, Taipei City (TW); Chun Tsao, Taipei City (TW); Yu-Cheng Shen, Taipei City (TW)

(73) Assignee: ASUSTeK COMPUTER INC., Taipei City (TW)

(21) Appl. No.: 19/346,459

(22) Filed: Sep. 30, 2025

(30) Foreign Application Priority Data
Dec. 5, 2024 (TW) 113147103

(51) Int. Cl. H01M 10/44; H02J 7/00

(52) U.S. Cl. CPC H01M 10/44; H02J 7/685; H02J 7/84; H02J 7/94

(57) ABSTRACT

An electronic device and a battery management method of the electronic device are provided. The method includes following steps. In a power connection mode, during a period when a battery care mode is activated, whether a battery module is in a fully charged storage status is determined. When the battery module is in the fully charged storage status, whether a current stored power of the battery module reaches a fully charged capacity is determined. When the current stored power of the battery module in the fully charged storage status reaches the fully charged capacity, a battery recharging capacity and a charging current limit are reduced in stages.

### CROSS-REFERENCE TO RELATED APPLICATION

This application claims the priority benefit of Taiwan application serial no. 113147103, filed on Dec. 5, 2024. The entirety of the above-mentioned patent application is hereby incorporated by reference herein and made a part of this specification.

### BACKGROUND

### Technical Field

The disclosure relates to an electronic device and a battery management method adopted by the electronic device.

### Description of Related Art

In today's handheld electronic devices (e.g., laptops, mobile phones, digital cameras, or tablet computers), batteries play a crucial role in power supply. However, if a power adapter (e.g., an AC adapter) remains plugged into the electronic device for an extended period, the battery can stay in a fully charged state for too long. This prolonged charging can accelerate battery aging and increase the risk of battery swelling, thereby negatively impacting the user experience.

### SUMMARY

An embodiment of the disclosure provides a battery management method adapted to an electronic device including a battery module. The method includes following steps. In a power connection mode, whether the battery module is in a fully charged storage status during a period when a battery care mode is activated is determined. Whether a current stored power of the battery module reaches a fully charged capacity is determined when the battery module is in the fully charged storage status. A battery recharging capacity and a charging current limit are reduced in stages when the current stored power of the battery module in the fully charged storage status reaches the fully charged capacity.

Another embodiment of the disclosure provides an electronic device that includes a battery module and a controller. The battery module includes a battery cell pack and a control circuit. The controller is coupled to the battery module and configured to set a fully charged capacity and a battery recharging capacity of the battery module. During a period when a battery care mode is activated in a power connection mode, the controller determines whether the battery module is in a fully charged storage status. When the battery module is in the fully charged storage status, the controller determines whether a current stored power of the battery module reaches the fully charged capacity through the control circuit. When the current stored power of the battery module in the fully charged storage status reaches the fully charged capacity, the controller reduces the battery recharging capacity and a charging current limit in stages.

Based on the above, the electronic device and the battery management method thereof as provided in one or more embodiments of the disclosure can apply the machine learning technology to monitor the status and the current stored power of the battery module, so as to understand usage scenarios and habits of users and accordingly actively and flexibly adjust the battery recharging capacity and the charging current limit. As such, battery aging can be mitigated, the cycle lifetime capacity of the battery can be improved, and the risk of battery swelling can be reduced without negatively impacting the user experience.

To make the above features and advantages of the disclosure more apparent and understandable, embodiments are described below with reference to the accompanying drawings for detailed explanation as follows.

### BRIEF DESCRIPTION OF THE DRAWINGS

FIG. 1 is a schematic block diagram illustrating an electronic device according to an embodiment of the disclosure.

FIG. 2 is a flowchart of a battery management method according to an embodiment of the disclosure.

FIG. 3A and FIG. 3B are flowcharts of a battery management method according to an embodiment of the disclosure.

FIG. 4 is a flowchart of a battery management method according to an embodiment of the disclosure.

FIG. 5 illustrates an example of a battery management method according to an embodiment of the disclosure.

### DESCRIPTION OF THE EMBODIMENTS

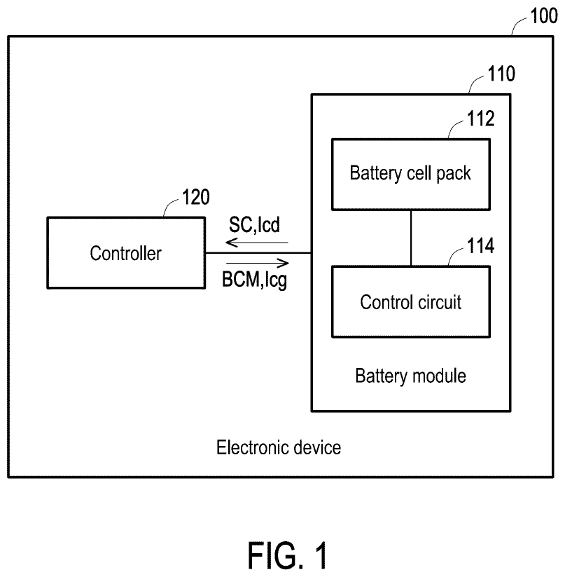

With reference to FIG. 1, an electronic device 100 provided in this embodiment may be a handheld electronic device, such as a laptop computer, a mobile phone, a digital camera, a tablet computer, or the like. The electronic device 100 includes a battery module 110 and a controller 120.

The battery module 110 can serve to power the electronic device 100 and can be embedded or externally connected. The battery module 110 includes a battery cell pack 112 and a control circuit 114. The battery cell pack 112 may be composed of a single battery cell or multiple battery cells (individual battery cells). The control circuit 114 can be implemented in the form of a battery gauge IC or a microcontroller, for instance. The control circuit 114 is coupled to the battery cell pack 112 and can calculate a current stored power SC and a charging and discharging current value Icd of the battery module 110 and report the current stored power SC and the charging and discharging current value Icd to the controller 120. Generally, when the battery module 110 is being charged via a power adapter (such as an AC adapter), the charging and discharging current value Icd reported by the control circuit 114 is positive. When the battery module 110 is being discharged due to powering the electronic device 100, the charging and discharging current value Icd reported by the control circuit 114 is negative.

The controller 120 is coupled to the battery module 110. The controller 120 is, for instance, an embedded controller (EC) or a microcontroller that can communicate with the battery module 110 through a communication protocol. The communication protocol is, for instance, a system management bus (SMBus) or an inter-integrated circuit (I²C), which should not be construed as a limitation in this embodiment.

The controller 120 can preset a fully charged capacity FC of the battery module 110. For instance, the fully charged capacity FC can be set within a range of 100% to 50% (usually less than 100%). When the fully charged capacity FC is set to 80%, once the current stored power SC of the battery module 110 is charged to 80%, the charging operation stops, thereby ensuring that the current stored power SC of the battery module 110 does not exceed 80%, thus avoiding the battery module 110 from being in a fully charged status (completely full).

Besides, in this embodiment, the controller 120 can also set a battery recharging capacity IRC to be used when the battery care mode is activated. For instance, the battery recharging capacity IRC may be set within a range from the fully charged capacity FC to 0%. During the period when the battery care mode is activated, if the battery recharging capacity IRC is set to 78%, charging of the battery module 110 is enabled once the current stored power SC of the battery module 110, which is currently disabled from charging, drops below 78%. At this point, power is recharged according to the normal charging current Icg, allowing the current stored power SC of the battery module 110 to begin increasing. When the current stored power SC of the battery module 110 rises to equal the battery recharging capacity IRC, the charging current Icg is reduced, and recharging continues until a specified fully recharged capacity (the fully charged capacity FC, which ranges from 50 to 100%) is reached. Related examples of the battery recharging capacity IRC can be found in the following description.

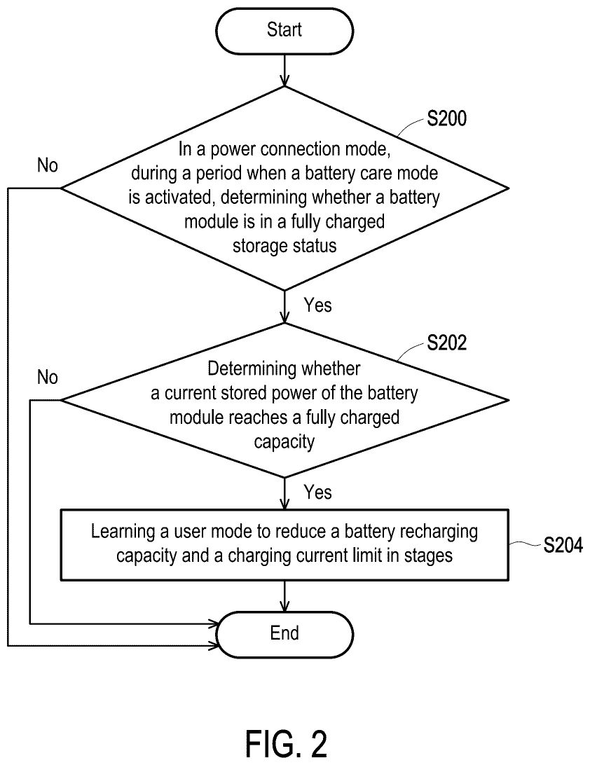

An embodiment is provided hereinafter to illustrate detailed steps of the battery management method of this disclosure. Please refer to both FIG. 1 and FIG. 2. The battery management method provided in the embodiment can be applicable to the electronic device 100 in FIG. 1, and steps of the method are described as follows.

In step S200, in a power connection mode, during a period when a battery care mode is activated, a controller 120 determines whether a battery module 110 is in a fully charged storage status. In this embodiment, the fully charged storage status represents a status where a charging and discharging current value Icd reported by a control circuit 114 ranges from 0 to a negative threshold value (e.g., −50 mA), which can reflect at least one of the following: (1) in the power connection mode, the current stored power SC of the battery module 110 has been charged to the fully charged capacity FC, and then the charging stops; (2) in the power connection mode, during the period when the charging of the battery module 110 is disabled, the power adapter connected to the physical circuits supporting a self-discharge function within the battery module 110 may be insufficient in wattage because the electronic device 100 performs power-consuming operations, such as running games, thus resulting in the need of supplying power to the battery module 110 and generating a small discharge current (50 mA or less). Accordingly, the current stored power SC of the battery module 110 gradually decreases.

When the power adapter is plugged into the electronic device 100, the electronic device 100 enters the power connection mode indicating that a power adapter is connected. On the contrary, when the power adapter 200 is unplugged from the electronic device 100, the electronic device 100 disables the power connection mode. In the power connection mode, the controller 120 can determine whether the battery care mode is activated. Specifically, the controller 120 can determine whether the battery care mode is activated according to the settings in an application program associated with power management. When the battery care mode is activated in the power connection mode, the controller 120 can output a battery care mode activation command BCM to the battery module 110, causing the battery module 110 to enter the battery care mode. During the period when the battery care mode is activated (the battery module 110 enters the battery care mode), the controller 120 can determine whether the battery module 110 is in a fully charged storage status based on the charging and discharging current value Icd reported by the control circuit 114.

When the battery module 110 is not in a fully charged storage status nor in the power connection mode, the current process ends. When the battery module 110 is in a fully charged storage status and in the power connection mode, in step S202, the controller 120 determines through the control circuit 114 whether the current stored power SC of the battery module 110 reaches the fully charged capacity FC.

When the current stored power SC of the battery module 110 in the fully charged storage status does not reach the fully charged capacity FC, the current process ends. When the current stored power SC of the battery module 110 in the fully charged storage status reaches the fully charged capacity FC, it indicates that in the power connection mode, the current stored power SC of the battery module 110 has been charged to the fully charged capacity FC, and the charging stops. In step S204, the controller 120 learns a user mode to reduce a battery recharging capacity IRC and adjust a charging current limit in stages. For instance, the controller 120 may reduce the battery recharging capacity IRC and adjust the charging current Icg in stages to be within a preset range. When the battery recharging capacity IRC is 78%, the controller 120 may reduce the battery recharging capacity IRC to 76%. When the battery recharging capacity IRC is 76%, the controller 120 may reduce the battery recharging capacity IRC to 74%, and the rest can be deduced therefrom. In addition, when the battery recharging capacity IRC is below 78%, the charging of the battery module 110 can be enabled, and the power may be recharged according to a normal charging current Icg. When the battery recharging capacity IRC equals 78%, the charging current Icg can be reduced, and recharging may continue until a specified fully recharged capacity (the fully charged capacity FC, which ranges from 50 to 100%) has been reached.

As such, in the next instance the current stored power SC of the battery module 110 begins to increase, it merely occurs after a lower battery recharging capacity IRC has been reached.

Moreover, if the current stored power SC of the battery module 110 is higher than the fully charged capacity FC, the charging of the battery module 110 may be disabled (unable to charge). At this time, a physical circuit may serve to discharge the battery module 110 or allow the current stored power SC to automatically drop below the fully charged capacity FC before the charging is performed to charge the battery module 110 to the fully charged capacity FC.

Incidentally, as long as the power adapter is plugged into the electronic device 100 (the power connection mode), the controller 120 can repeatedly perform the steps of determining whether the battery module 110 is in the fully charged storage status, determining whether the current stored power SC of the battery module 110 reaches the fully charged capacity FC, and reducing the battery recharging capacity IRC and the charging current Icg in stages (i.e., the steps shown in FIG. 2) until the power adapter is unplugged, causing the electronic device 100 to exit the power connection mode.

Through the aforementioned method, the machine learning technology may be utilized to monitor the situation when the battery module 110 reaches the fully charged capacity FC, so as to actively and flexibly adjust the battery recharging capacity IRC and the charging current Icg, thereby mitigating battery aging, improving the cycle lifetime capacity, and reducing the risk of battery swelling.

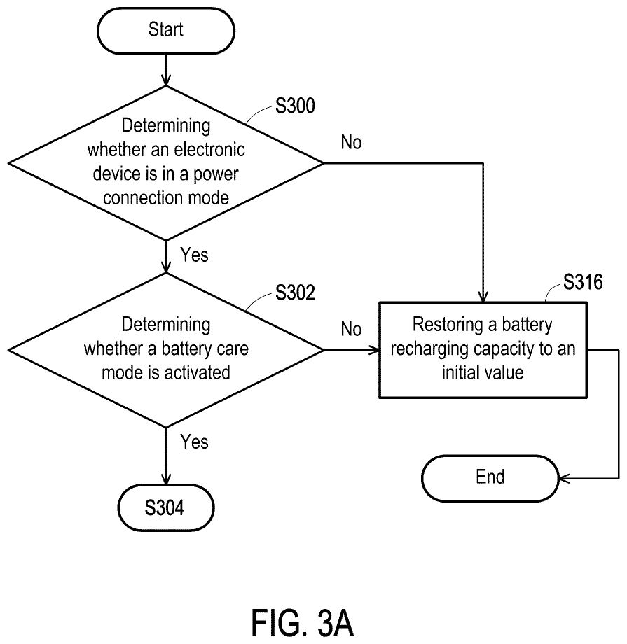

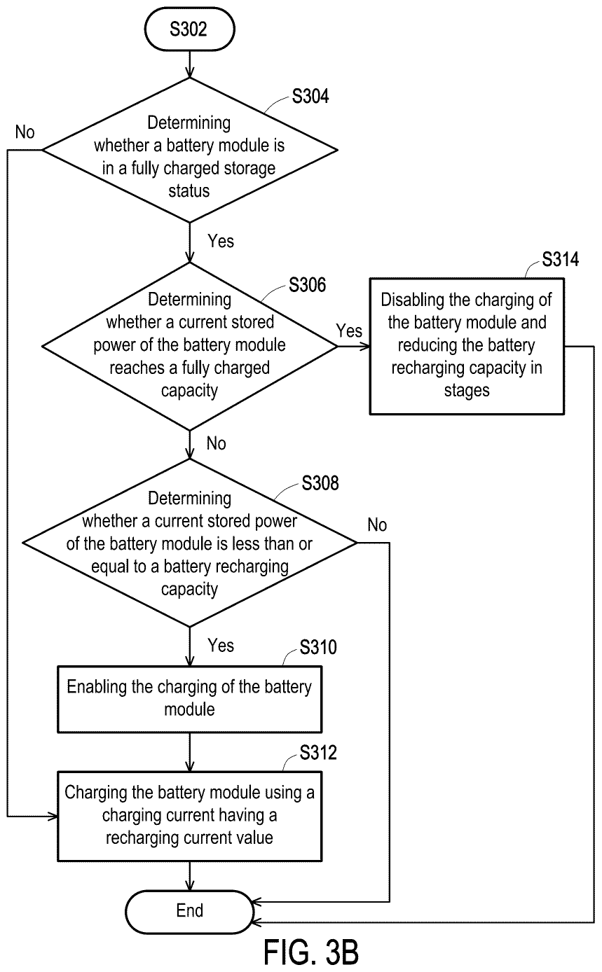

Another embodiment is provided below to explain in detail the battery management method of this disclosure. Please refer to FIG. 1, FIG. 3A, and FIG. 3B simultaneously. The battery management method provided in the embodiment may be applicable to the electronic device 100 in FIG. 1, and steps of the method are described as follows.

First, in step S300, a controller 120 determines whether an electronic device 100 is in a power connection mode. If yes, then in step S302, the controller 120 determines whether a battery care mode is activated. In this embodiment, when the battery care mode is initially activated, the controller 120 sets a battery module 110 of which the charging is disabled by default.

When the battery care mode is activated, step S304 in FIG. 3B is performed. In step S304, the controller 120 determines whether the battery module 110 is in a fully charged storage status.

When the battery module 110 is in a fully charged storage status, in step S306, the controller 120 determines through a control circuit 114 whether a current stored power SC of the battery module 110 reaches a fully charged capacity FC.

When the current stored power SC of the battery module 110 in the fully charged storage status does not reach the fully charged capacity FC, it indicates that in the power connection mode, during a period when the charging of the battery module 110 is disabled, the current stored power SC of the battery module 110 gradually decreases. At this time, in step S308, the controller 120 determines through the control circuit 114 whether the current stored power SC of the battery module 110 is less than or equal to a battery recharging capacity IRC. If not, it indicates that the current stored power SC has not yet decreased to reach the battery recharging capacity IRC, and thus this process ends. If yes, it indicates that the current stored power SC has decreased to reach the battery recharging capacity IRC. In step S310, the controller 120 enables the charging of the battery module 110. In step S312, the controller 120, for instance, charges the battery module 110 using the charging current Icg having a recharging current value through a charger IC.

After the charging of the battery module 110 is enabled and the charging using the charging current Icg having the recharging current value begins, the battery module 110 transitions to a non-fully charged storage status. In this situation, in step S304, the controller 120 determines that the battery module 110 is not in the fully charged storage status. At this time, step S312 is directly performed, where the controller 120 continues to charge the battery module 110 using the charging current Icg having the recharging current value.

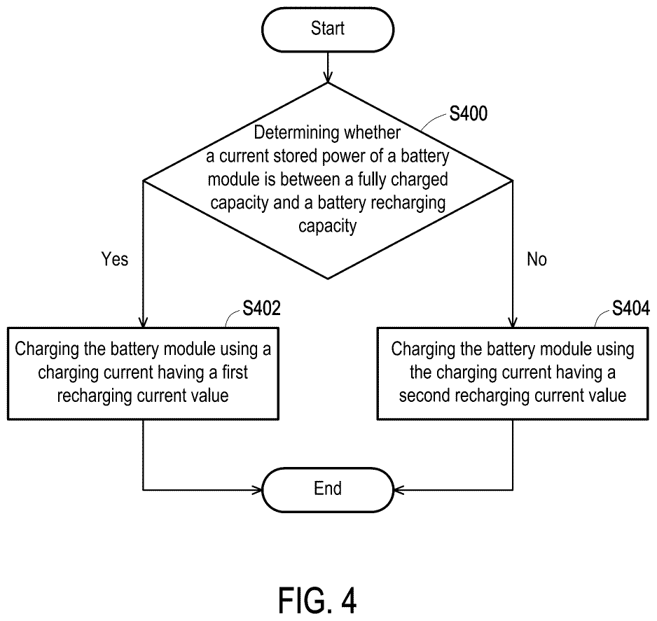

The recharging current value provided in this embodiment can vary according to the magnitude of the current stored power SC of the battery module 110 and can include a first recharging current value and a second recharging current value greater than the first recharging current value. For instance, during the period when the charging of the battery module 110 is enabled, the detailed steps of charging the battery module 110 using the charging current Icg having the recharging current value can be referred to as steps S400, S402, and S404 in FIG. 4. Please refer to FIG. 1 and FIG. 4 simultaneously. First, in step S400, the controller 120 determines through the control circuit 114 whether the current stored power SC of the battery module 110 is between the fully charged capacity FC and the battery recharging capacity IRC.

If the current stored power SC is between the fully charged capacity FC and the battery recharging capacity IRC, it indicates that after the charging of the battery module 110 is enabled, the current stored power SC of the battery module 110 gradually increases from the battery recharging capacity IRC towards the fully charged capacity FC. In step S402, the controller 120 charges the battery module 110 using the charging current Icg having the first recharging current value.

If the current stored power SC is not between the fully charged capacity FC and the battery recharging capacity IRC, it indicates that after the charging of the battery module 110 is enabled, possibly due to the electronic device 100 performing more power-consuming operations, the current stored power SC of the battery module 110 continues to decrease from the battery recharging capacity IRC. In step S404, the controller 120 charges the battery module 110 using the charging current Icg having the second recharging current value (greater than the first recharging current value).

In practical applications, the first recharging current value is, for instance, 0.2 c amperes (where c is the unit current value obtained based on the battery capacity of the battery module 110), and the second recharging current value is, for instance, 1.1 c amperes (equivalent to the originally set charging current value of the battery module 110), which should not be construed as a limitation in the disclosure.

Please return to FIG. 3B. In a situation where the current stored power SC of the battery module 110 is charged to the fully charged capacity FC using the charging current Icg having the recharging current value, the battery module 110 transitions from a non-fully charged storage status to a fully charged storage status. When the controller 120 determines through the control circuit 114 that the current stored power SC of the battery module 110 in the fully charged storage status reaches the fully charged capacity FC in step S306, it indicates that after the charging of the battery module 110 is enabled, the current stored power SC of the battery module 110 has been charged from the battery recharging capacity IRC to the fully charged capacity FC, and the charging stops. At this time, in step S314, the controller 120 disables the charging of the battery module 110 and reduces the battery recharging capacity IRC in stages. As such, in the next instance the current stored power SC of the battery module 110 reaches an even lower battery recharging capacity IRC, the current stored power SC begins to increase.

In one embodiment of the disclosure, when the current stored power SC of the battery module 110 in the fully charged storage status reaches the fully charged capacity FC, in step S314, in addition to reducing the battery recharging capacity IRC in stages, the controller 120 can also reduce the recharging current value in stages. As such, in the next instance after the current stored power SC of the battery module 110 decreases to reach the battery recharging capacity IRC, the battery module 110 is charged using the charging current Icg having a lower recharging current value.

In FIG. 3A, when the controller 120 determines in step S300 that the electronic device 100 is not in the power connection mode (the power connection mode is disengaged), the controller 120 restores the battery recharging capacity IRC to its initial value (e.g., 78%) in step S316. Similarly, when the controller 120 determines in step S302 that the battery care mode is not activated, the controller 120 also restores the battery recharging capacity IRC to its initial value in step S316.

Moreover, in one embodiment of the disclosure, the controller 120 may determine whether the current stored power SC of the battery module 110 decreases to be less than the battery recharging capacity IRC. If yes, the controller 120 can further reduce the battery recharging capacity IRC.

Incidentally, the controller 120 may continuously repeat the steps shown in FIG. 3A and FIG. 3B to continuously adjust the battery recharging capacity IRC, thereby achieving the effect of maintaining the battery module 110.

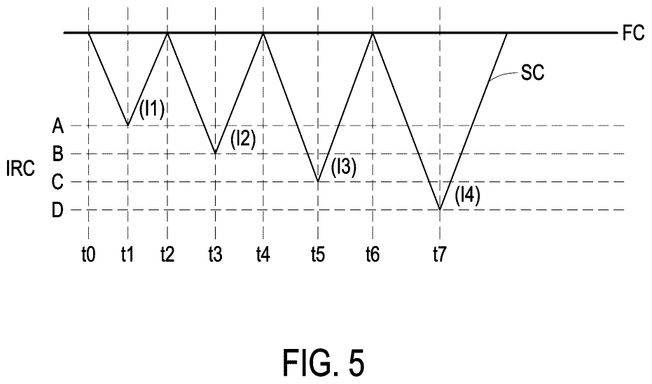

To be specific, for instance, FIG. 5 illustrates an example of timing variations of the current stored power SC of the battery module 110 when the battery care mode is activated in the power connection mode. To facilitate explanations, in FIG. 5, the fully charged capacity FC is set to 80%, the initial value A of the battery recharging capacity IRC is set to 78%, and the adjustment values B, C, and D of the battery recharging capacity IRC are set to 76%, 74%, and 72%, respectively, which should however not be construed as limitations in the disclosure.

At a time point t0, the battery module 110 is preset to disable the charging, and therefore the current stored power SC of the battery module 110 begins to gradually decrease. Between the time point t0 and a time point t1, the battery module 110 is in the fully charged storage status.

When the current stored power SC of the battery module 110 decreases to reach an initial value A (i.e., at the time point t1), the controller 120 enables the charging of the battery module 110. Then, the controller 120 begins to charge the battery module 110 using the charging current Icg having the recharging current value I1.

After the charging of the battery module 110 is enabled and the charging begins using the charging current Icg having the recharging current value I1, the battery module 110 transitions to a non-fully charged storage status. The controller 120 continues to charge the battery module 110 using the charging current Icg having the recharging current value I1.

At a time point t2, when the current stored power SC of the battery module 110 is charged to reach the fully charged capacity FC using the charging current Icg having the recharging current value I1, the battery module 110 transitions from the non-fully charged storage status to the fully charged storage status. At this time, the controller 120 disables the charging of the battery module 110 and reduces the battery recharging capacity IRC to an adjustment value B. Subsequently, the current stored power SC of the battery module 110 begins to gradually decrease again.

When the current stored power SC of the battery module 110 decreases to reach the adjustment value B (i.e., at a time point t3), the controller 120 enables the charging of the battery module 110. Then, the controller 120 begins to charge the battery module 110 using the charging current Icg having the recharging current value I2.

After the charging of the battery module 110 is enabled and the charging begins using the charging current Icg having the recharging current value I2, the battery module 110 transitions to a non-fully charged storage status. The controller 120 continues to charge the battery module 110 using the charging current Icg having the recharging current value I2.

At a time point t4, when the current stored power SC of the battery module 110 is charged to reach the fully charged capacity FC using the charging current Icg having the recharging current value I2, the battery module 110 transitions from the non-fully charged storage status to the fully charged storage status. At this time, the controller 120 disables the charging of the battery module 110 and reduces the battery recharging capacity IRC to an adjustment value C. Subsequently, the current stored power SC of the battery module 110 begins to gradually decrease again.

Similarly, at a time point t5, when the current stored power SC of the battery module 110 decreases to reach the adjustment value C, the controller 120 begins to charge the battery module 110 using the charging current Icg having the recharging current value I3. At a time point t6, the controller 120 reduces the battery recharging capacity IRC to an adjustment value D. At a time point t7, when the current stored power SC of the battery module 110 decreases to reach the adjustment value D, the controller 120 starts to charge the battery module 110 using the charging current Icg having the recharging current value I4.

In this embodiment, the recharging current values I1 to I4 can be equal to or less than the originally set charging current value, and the recharging current values I1 to I4 can also be equal or sequentially decrease (I4<I3<I2<I1), which should not be construed as limitations in the disclosure. Besides, although the battery recharging capacity IRC in this embodiment is sequentially reduced among 4 values (4 stages), which should not be construed as a limitation in the disclosure. Those skilled in the pertinent art may, according to actual needs and referring to teachings provided in this embodiment, sequentially reduce the battery recharging capacity IRC among fewer or more values (stages).

To sum up, the electronic device and the battery management method thereof provided in one or more embodiments of this disclosure can apply the machine learning technology to monitor the status and the stored power of the battery module, so as to understand the usage scenarios and the habits of the users and actively and flexibly adjust the battery recharging capacity and the charging current value based on the situation of reaching the fully charged capacity. As a result, battery aging can be mitigated, cycle lifetime capacity can be improved, and the risk of battery swelling can be reduced without negatively impacting the user experience.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents

What is claimed is:

1. A battery management method, adapted for an electronic device comprising a battery module, the battery management method comprising:
in a power connection mode, determining whether the battery module is in a fully charged storage status during a period when a battery care mode is activated;
determining whether a current stored power of the battery module reaches a fully charged capacity when the battery module is in the fully charged storage status; and
reducing a battery recharging capacity and a charging current limit in stages when the current stored power of the battery module in the fully charged storage status reaches the fully charged capacity.

2. The battery management method according to claim 1, wherein the fully charged storage status represents a status where a charging and discharging current value of the battery module ranges from 0 to a negative threshold value.

3. The battery management method according to claim 1, further comprising:
when the battery module is not in the fully charged storage status, charging the battery module using the charging current having a recharging current value.

4. The battery management method according to claim 3, wherein in a situation where the current stored power of the battery module is charged to the fully charged capacity using the charging current having the recharging current value, the battery module transitions to the fully charged storage status.

5. The battery management method according to claim 1, further comprising:
determining whether the current stored power of the battery module is less than or equal to the battery recharging capacity when the current stored power of the battery module in the fully charged storage status does not reach the fully charged capacity; and
if yes, enabling charging of the battery module and charging the battery module using the charging current having a recharging current value.

6. The battery management method according to claim 5, wherein the recharging current value comprises a first recharging current value and a second recharging current value greater than the first recharging current value,
and the step of charging the battery module using the charging current having the recharging current value comprises:
determining whether the current stored power of the battery module is between the fully charged capacity and the battery recharging capacity during a period of enabling the charging of the battery module;
if yes, charging the battery module using the charging current having the first recharging current value; and
if no, charging the battery module using the charging current having the second recharging current value.

7. The battery management method according to claim 5, further comprising:
disabling charging of the battery module when the current stored power of the battery module in the fully charged storage status reaches the fully charged capacity.

8. The battery management method according to claim 3, further comprising:
reducing the recharging current value in stages when the current stored power of the battery module in the fully charged storage status reaches the fully charged capacity.

9. The battery management method according to claim 1, further comprising:
restoring the battery recharging capacity to an initial value when the power connection mode is disengaged.

10. The battery management method according to claim 1, further comprising:
determining whether the current stored power of the battery module drops below the battery recharging capacity; and
if yes, further reducing the battery recharging capacity.

11. An electronic device, comprising:
a battery module, comprising a battery cell pack and a control circuit; and
a controller, coupled to the battery module and configured to set a fully charged capacity and a battery recharging capacity of the battery module, wherein during a period when a battery care mode is activated in a power connection mode, the controller determines whether the battery module is in a fully charged storage status,
when the battery module is in the fully charged storage status, the controller determines whether a current stored power of the battery module reaches the fully charged capacity through the control circuit,
when the current stored power of the battery module in the fully charged storage status reaches the fully charged capacity, the controller reduces a battery recharging capacity and a charging current limit in stages.

12. The electronic device according to claim 11, wherein the fully charged storage status represents a status where a charging and discharging current value of the battery module reported by the control circuit ranges from 0 to a negative threshold value.

13. The electronic device according to claim 11, wherein when the battery module is not in the fully charged storage status, the controller charges the battery module using the charging current having a recharging current value.

14. The electronic device according to claim 13, wherein in the situation where the current stored power of the battery module is charged to the fully charged capacity using the charging current having the recharging current value, the battery module transitions to the fully charged storage status.

15. The electronic device according to claim 11, wherein when the current stored power of the battery module in the fully charged storage status does not reach the fully charged capacity, the controller determines whether the current stored power of the battery module is less than or equal to the battery recharging capacity through the control circuit, and
if yes, the controller enables charging of the battery module and charges the battery module using the charging current having a recharging current value.

16. The electronic device according to claim 15, wherein the recharging current value comprises a first recharging current value and a second recharging current value greater than the first recharging current value,
during a period of enabling the charging of the battery module, the controller determines whether the current stored power of the battery module is between the fully charged capacity and the battery recharging capacity through the control circuit,
if yes, the controller charges the battery module using the charging current having the first recharging current value, and
if no, the controller charges the battery module using the charging current having the second recharging current value.

17. The electronic device according to claim 15, wherein when the current stored power of the battery module in the fully charged storage status reaches the fully charged capacity, the controller disables charging of the battery module.

18. The electronic device according to claim 13, wherein when the current stored power of the battery module in the fully charged storage status reaches the fully charged capacity, the controller reduces the recharging current value in stages.

19. The electronic device according to claim 11, wherein when the power connection mode is disengaged, the controller restores the battery recharging capacity to an initial value.

20. The electronic device according to claim 11, wherein the controller determines whether the current stored power of the battery module drops below the battery recharging capacity, and
if yes, the controller further reduces the battery recharging capacity.
